(19) United States
(12) Patent Application Publication
(10) Pub. No.: US 2002/0130955 A1
(43) Pub. Date: Sep. 19, 2002

(54) Method and apparatus for determining camera movement control criteria

(76) Inventor: Daniel Pelletier, Lake Peekskill, NY (US)

Correspondence Address: Jack E. Haken, c/o U.S. PHILIPS CORPORATION, Intellectual Property Department, 580 White Plains Road, Tarrytown, NY, 10591, US

(21) Appl. No.: 09/759,486

(22) Filed: Jan. 12, 2001

(51) Int. Cl. H04N 5/232

(52) U.S. Cl. 348/211

(57) ABSTRACT

The present invention incorporates known cinematographic procedures with computer rendered representation of images within a scene to capture high quality, pleasantly viewable images based on the content of a recorded scene. The present invention dynamically determines the criteria necessary to control camera movement to perform a known camera movement sequence based on computer determined scene content. By knowing, for example, the number and position of objects in a scene, the criteria for controlling the camera movement to achieve a known camera movement sequence may be determined.

### FIELD OF THE INVENTION

This invention relates to camera control. More specifically, this invention relates to dynamically determining criteria used to control camera movement sequences based on the content of the scene being viewed.

### BACKGROUND OF THE INVENTION

Cinematography techniques are well known in the art. Many cinematographic techniques have been in continuous development since the development of the first motion picture camera. Consequently, many techniques have been developed empirically which achieve a pleasantly viewable recording of a scene or image. Techniques such as the panning duration, zoom degree and speed, and camera tilt angle have been varied and tested to find a panning rate, zoom rate and tilt angle, that achieves an image that is pleasing to an observer.

As new innovations enter the cinematographer industry, the cinematographer continues to experiment with different ways of capturing and displaying a scene. For example, different camera angles may be used to capture a scene in order to change a viewer's perspective of the scene. Also, different record times may be used to capture a viewer's attention, or to concentrate the viewer's attention on specific objects in a scene.

With this vast amount of experimentation in camera technique development, empirically derived standards have emerged with regard to specific aspects of capturing a scene on film, magnetic tape, or real-time transmittal, for example, in television transmission. These empirically derived standards are well known to the experienced practitioner, but are not generally known to the average or occasional user. Hence, an average or occasional camera user desiring to pan a scene may proceed too quickly or too slowly. The resultant captured image in either case is unpleasant to view as the images are shown for either too short a period of time or too long a period of time. Thus, to record high quality pleasantly viewable images, a user must devote a considerable amount of time and effort to obtain the skills needed to execute these empirically derived standards. Alternatively, occasional users must seek and employ persons who already have achieved the necessary skills needed to operate camera equipment in accordance with the derived standards. In the former case, the time and effort spent to acquire necessary skills is burdensome and wasteful as the skills must be continuously practiced and updated. In the latter case, skilled personnel are continually needed to perform tasks that are fairly routine and well known. Hence, there is a need to incorporate cinematographic techniques using empirically derived standards into camera equipment that will enable users to produce high quality pleasantly viewable images without undue burden and experimentation.

### SUMMARY OF THE INVENTION

The present invention incorporates cinematographic procedures with computer rendered representations of images within a scene to create high quality, pleasantly viewable images based on the content of a recorded scene. The present invention comprises a method and apparatus for determining criteria for the automatic control of a known camera. More specifically, a first input is received for selecting at least one known sequence of camera parametrics from a plurality of known sequences of camera parametrics, wherein the selected camera parametrics provide generalized instructions for performing known camera movements. A second input consisting of high level parameters that are representative of objects in a scene are also inputs to the invention. The invention then determines, in response to the high level parameters, criteria to execute the selected known sequence of camera parametrics and provides at least one output for adjusting camera movement in response to the sequence criteria.

### BRIEF DESCRIPTION OF THE DRAWINGS

In the drawings:

FIG. 1 illustrates a block diagram of the processing in accordance with the principles of the invention;

FIG. 2a illustrates an exemplary image depicting recognizable scene objects;

FIG. 2b illustrates a change in camera view of an object depicted in FIG. 2a in accordance with the principles of the invention;

FIG. 3a illustrates an exemplary processing flow chart in accordance with the principles of the present invention;

FIG. 3b illustrates an exemplary processing flow chart determining camera control criteria in accordance with the principles of the present invention;

FIG. 4a illustrates an exemplary embodiment of the present invention; and

FIG. 4b illustrates a second exemplary embodiment of the present invention.

It is to be understood that these drawings are solely for purposes of illustrating the concepts of the invention and are not intended as a level of the limits of the invention. It will be appreciated that the same reference numerals, possibly supplemented with reference characters where appropriate, have been used throughout to identify corresponding parts.

### DETAILED DESCRIPTION OF THE INVENTION

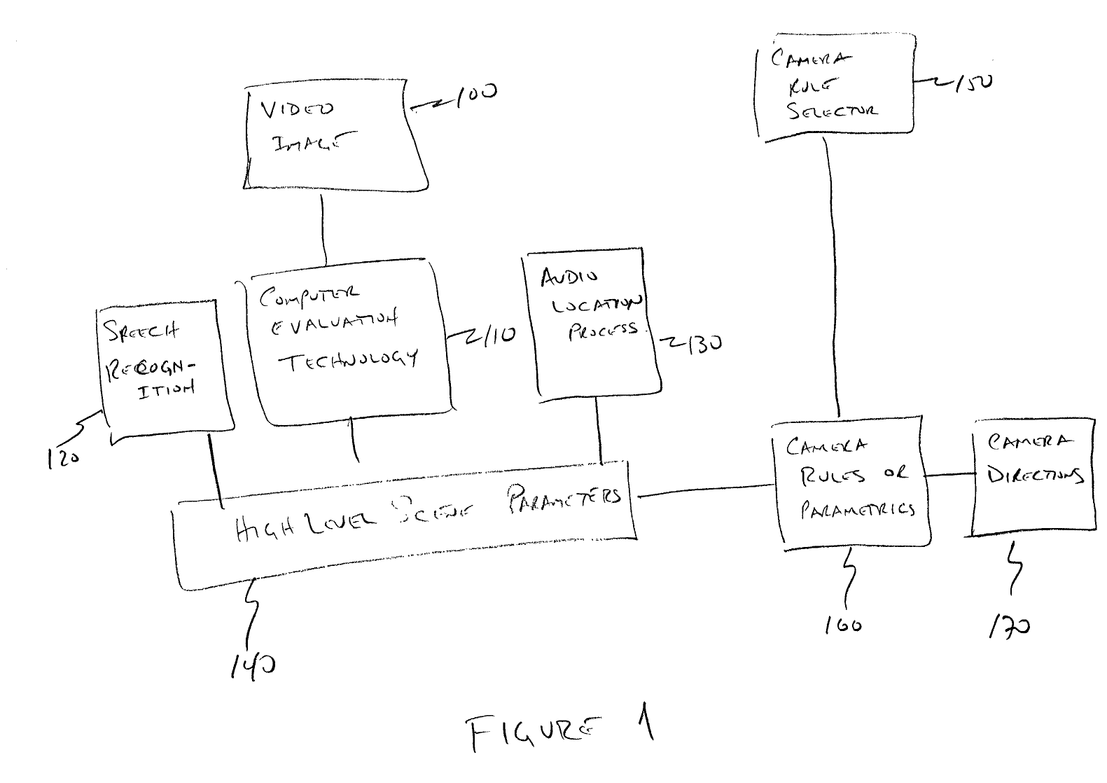

FIG. 1 illustrates, in block diagram format, a method for controlling camera sequences in accordance with the principles of the present invention. Video image 100 is analyzed by using conventional computer evaluation techniques, as represented in block 110, to determine high level parameters 140 of objects within video image 100. Computer evaluation techniques are used to evaluate a scene and enable a computing system to perceive the images in a scene. Images or objects recognized in the scene may be recorded for later processing, such as enhancement, filtering, coloring, etc. High level parameters 140 may include, for example, the number and position of objects within video image 100. Further, as illustrated, high level parameters 140 may also include speech recognition 120 and audio location processing 130. Speech recognition 120 can be used to determine a specific object speaking within a scene. Audio location 130 can be used to determine the source of sound within a scene.

Generic camera sequence rules or parametrics 160 determine the criteria necessary to implement known processing steps necessary to perform a user selected camera sequence based on the determined scene high level scene parameters 140. Camera sequence rules may be selected using camera sequence selector 150. Operational commands, as represented by camera directions 170, are then output to move or position a selected camera or camera lens in accordance with the selected camera sequence and the determined criteria.

1. Generic Rules for Known Camera Sequences.

In accordance with the principles of the invention, the generic rules or parametrics of camera sequence, previously referred to as rules 160 may be preloaded into a computing system, for example, which enable a selected camera to automatically perform and execute designated movements. Known camera sequence parametrics, which when supplied with information items from a designated scene, determine the criteria for camera movement necessary to achieve the desired operation. For example, exemplary rules, or parametrics, for camera movements associated with a typical close-up sequence are tabulated in Table 1 as follows;

TABLE 1
Exemplary Close-up Rules

| | |
|---|---|
| 1. | Locate objects in image |
| 2. | Determine object closest to center |
| 3. | Obtain frame area around object (proper headroom, sideroom, etc.) |
| 4. | Get current lens zoom level |
| 5. | Get known close-up standard |
| 6. | Determine change in zoom level to achieve close-up standard |
| 7. | Get known rate of zoom change |
| 8. | Determine time to execute zoom level change |
| 9. | Output zoom level change/unit time |

In this exemplary example, a camera zoom level or position may be changed from its current level to a second level at a known rate of change to produce a pleasantly viewable scene transition. In this case, at step 1, the objects are located within the image. At step 2, the object closest to the center is then determined. At step 3, a frame, i.e., percentage of the scene, around the object is then determined. At step 4, the current camera position or zoom level is determined and, at step 5, an empirically derived standard of a pleasantly viewed close-up is obtained. For example, a pleasantly viewed close-up may require that an object occupy seventy-five percent of a frame. At step 6, a determination is made as to the change in camera position or zoom level to achieve a known close-up standard. A known rate of change of camera position or zoom level change is then obtained at step 7. For example, a rate of zoom level change standard may require that an image double in size in a known time period, such as two seconds. At step 8, the time to perform a close-up based on the initial size of the identified close-up area, the final size of the identified close-up and a known rate of change may then be determined. At step 9, commands to direct camera movement or change in camera lens zoom level is output to a designated camera or camera motors which adjust camera lenses or an electronic zoom capability.

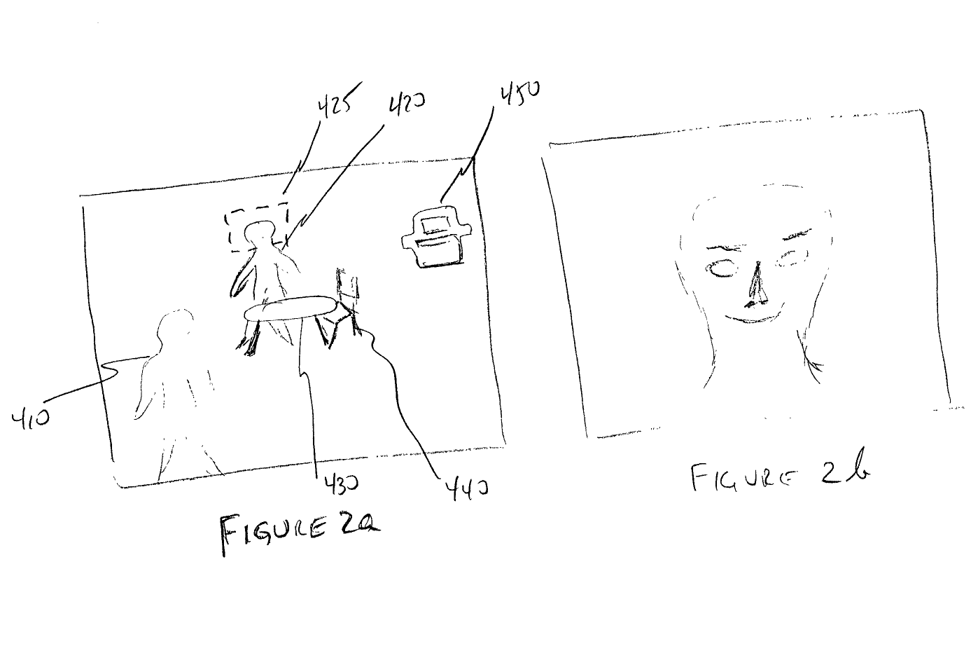

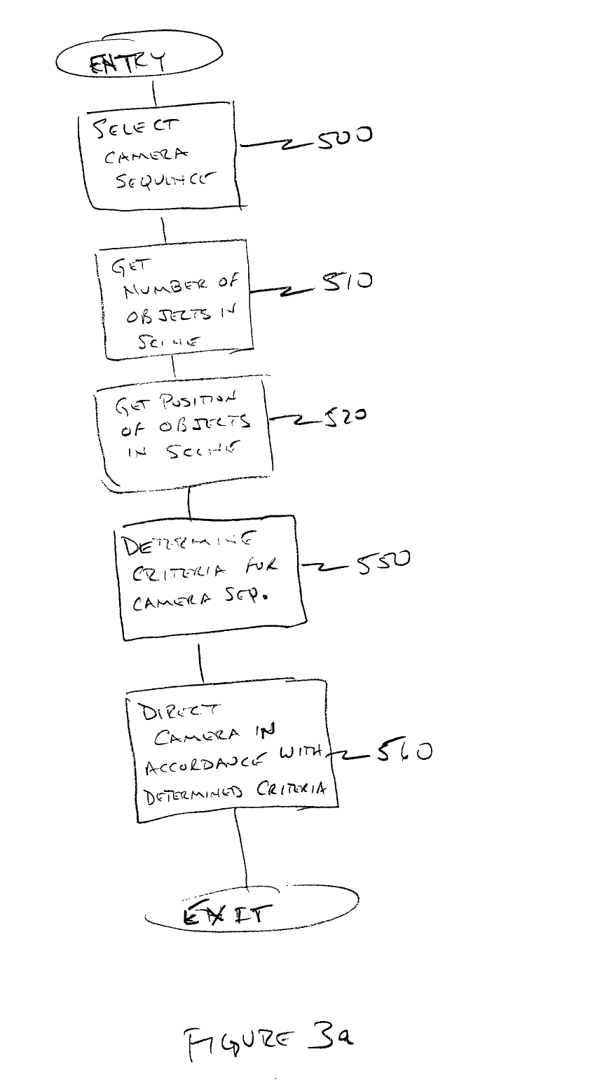

FIGS. 2a and 2b illustrate an example of the use of the present invention using the known camera sequence tabulated in Table 1. FIG. 2a illustrates a typical scene that includes at least five computer-vision recognizable or determined objects, i.e., person A 410, person B 420, couch 450, table 430 and chair 440, respectively. Further, area 425 around person B 420 is identified as a designated close-up area. FIG. 2b illustrates the viewable image when a close-up camera sequence is requested on the object denoted as person B 420. In this case, the camera controls are issued to change the zoom level of a camera lens from the current level to a level in which the designated area occupies a known percentage of the viewing frame.

As a second exemplary example, Table 2 tabulates generic rules, or parametrics, for performing a left-to-right panning sequence as follows:

TABLE 2
Exemplary Left-to-Right Panning Rules

| | |
|---|---|
| 1. | Determine current number and position of objects in scene |
| 2. | Locate leftmost object, right most object |
| 2. | Determine current zoom level |
| 3. | Determine zoom level based position of and distance between objects |
| | in scene |
| 4. | Output zoom level change, if necessary |
| 5. | Get known rate of panning speed |
| 6. | Get starting position |
| 7. | Determine angular degree of camera movement |
| 8. | Determine time to pan scene |
| 9. | Output angular change of camera position/unit time |

As would be appreciated, similar and more difficult camera sequences such as fade-in, fade-out, pan left and right, invert orientation, zoom and pull-back, etc., may be formulated, which can be used to determine camera control criteria based on content of a scene being recorded. Furtherstill, camera sequences rules may be executed in serial or in combination. For example, a pan left-to-right and close-up may be executed in combination by the camera is panning left-to-right while the zoom level is dynamically changed to have a selected object occupy a known percentage of the viewing frame.

2. Method Employing Rules-Based Camera Sequence Parametrics

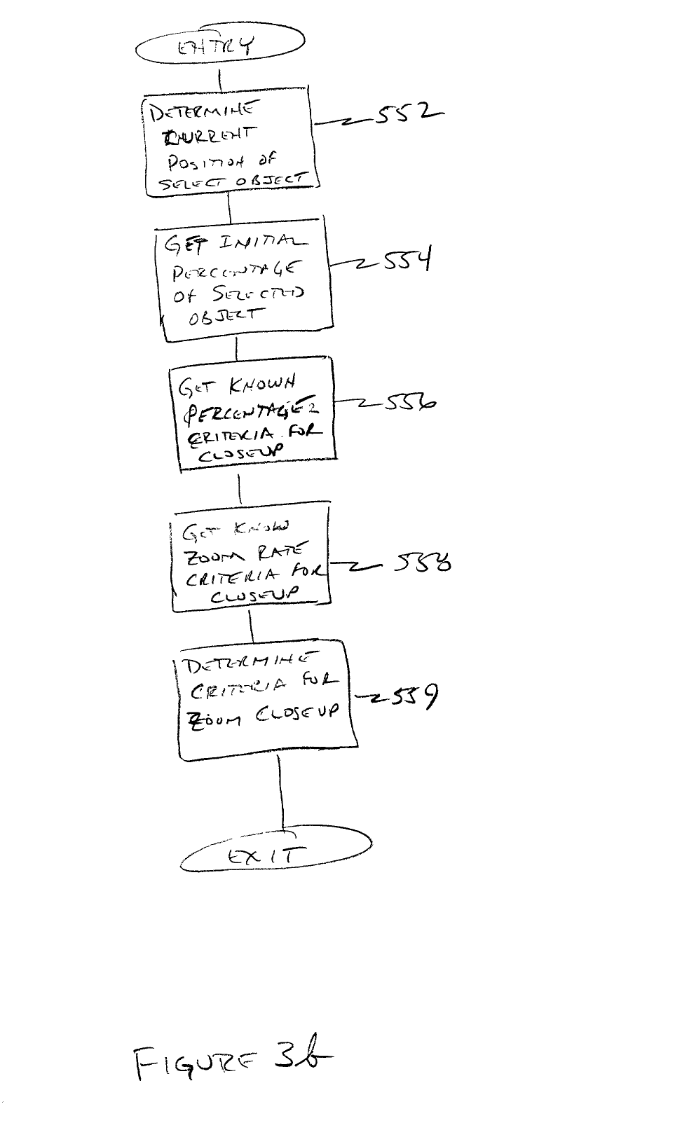

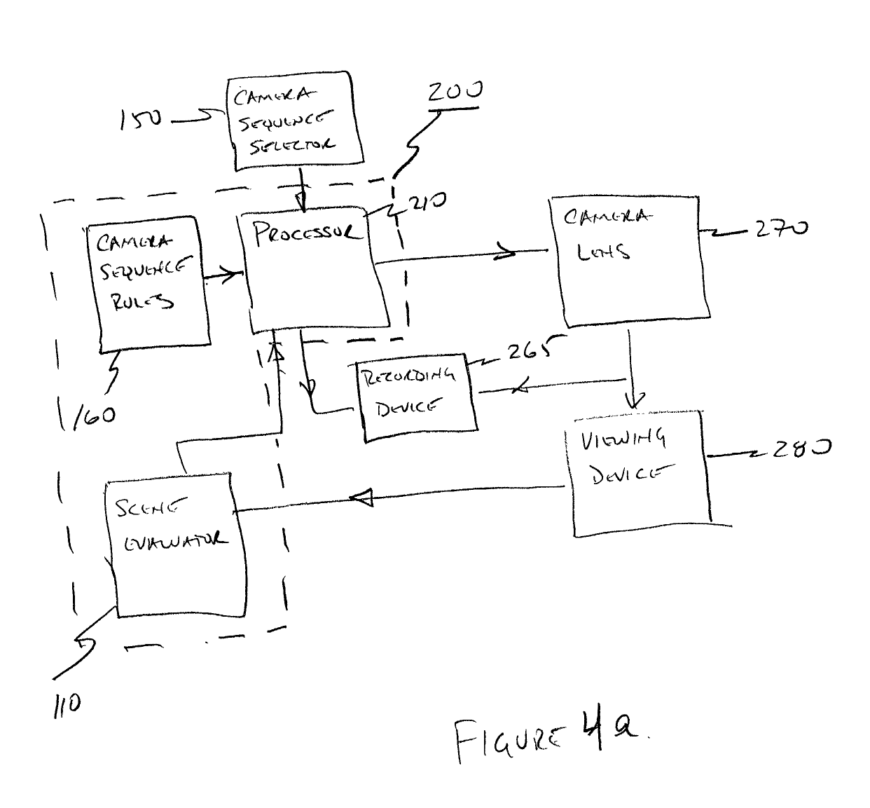

FIG. 3a illustrates a flow chart of exemplary processing which further details the steps depicted in FIG. 1. In this exemplary processing, a user selects, at block 500, a known camera movement sequence from a list of known camera movement sequences. High-level scene parameters, such as number and position of objects in the scene, are determined, at blocks 510 and 520 respectively. Responsive to the determination of the high level scene parameters, such as number and position of objects in the scene, criteria for camera or camera lens movement controls are dynamically determined, at block 550. The camera or camera lens movement controls are then sent to a selected camera or camera lens, at block 560, to execute the desired movements.

FIG. 3b illustrates a exemplary processing flow chart in determining criteria for controlling camera movement in regard to the scenes illustrated in FIGS. 2a and 2b, i.e., a close-up of the area 425 around object representative of person B 420, using the exemplary camera sequences tabulated in Table 1. In this case, the current position of object person B 420 and designated area 425 is determined, at block 552. Further, the initial percentage of the scene occupied by the desired close-up area of object person B 420 is determined at block 554. A known final percentage for pleasant close-up viewing is obtained for selected camera sequence “zoom-in,” at block 556. Further, a known rate of zooming to cause a known increase in the percentage of occupation of the frame is obtained at block 558. Criteria, such as total zoom-in time, camera centering, rate of camera zoom level change, etc, for controlling the camera movement or camera lens zoom level to achieve the user selected “close-up” are determined at block 559.

3. Apparatus and System Utilizing Method of Invention

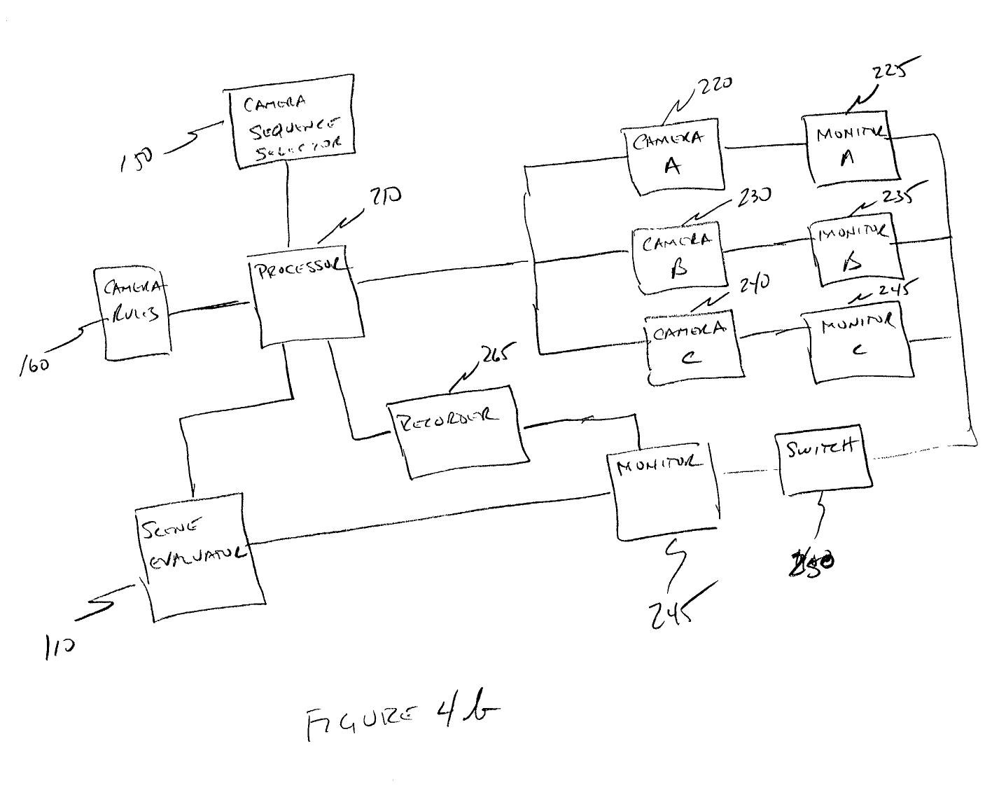

FIG. 4a illustrates an exemplary apparatus 200, e.g., a camcorder, a video-recorder, etc., utilizing the principles of the present invention. In this illustrative example, processor 210 is in communication with camera lens 270 to control, for example, the angle, orientation, zoom level, etc., of camera lens 270. Camera lens 270 captures the images of a scene and displays the images on viewing device 280. Camera lens 270 is further able to transfer the images viewed to recording device 265. Processor 210 is also in communication with recording device 265 to control the recording of images viewed by camera lens 270.

Apparatus 200 also includes camera sequence rules 160 and scene evaluator 110, which are in communication with processor 210. Camera sequence rules 160 are composed of generalized rules or instructions used to control a camera position, direction of travel, scene duration, camera orientation, etc., or a camera lens movement, as tabulated in the exemplary camera sequences tabulated in Tables 1 and 2. A camera sequence or technique may be selected using camera sequence selector 150.

Scene evaluator 110 evaluates the images received by a selected camera to determine scene high level parameters, such as the number and position of objects in a viewed image. The high level parameters are then used by processor 210 to dynamically determine the criteria for positioning and a positioning selected cameras or adjusting a camera lens in accordance with the user selected camera sequence rules.

FIG. 4b illustrates an exemplary system using the principles of the present invention. In this illustrative example, processor 210 is in communication with a plurality of cameras, e.g., camera A 220, camera B 230 and camera C 240 and recording device 265. Each camera is also in communication with a monitoring device. In this illustrative example, camera A 220 is in communication with monitor device 225, camera B 230 is in communication with monitoring device 235 and camera C 240 is in communication with monitoring device 245. Further, switch 250 is operative to select the images of a selected monitoring device and provide these images to monitoring device 260 for viewing. The images viewed on monitor 245 may then be recorded on recorder 265, which is under the control of processor 210.

Furthermore, scene evaluator 110 determines high-level scene parameters. In this example, the images viewed on monitor device 245. In another aspect of the invention, scene evaluator 110 may use images collected by camera A 220, camera B 230, camera C 240. The high-level parameters of at least one image is then provided to processor 210. Furthermore, at least one generic camera sequence rule from the stored camera sequence rules 160 may be selected using camera sequence selector 150.

Provided with the selected camera sequence and the high-level parameters representative of the objects in a selected scene, processor 210 determines camera movement controls that direct the movements of a selected camera. For example, processor 210 may select camera A 220 and then control the position, angle, direction, etc., of the selected camera with respect to objects in a scene. In another aspect, processor 210 can determine the framing of an image by controlling a selected camera lens zoom-in and zoom-out function or change the lens aperture to increase or decease the amount of light captured.

An example of the illustrative system of FIG. 4b is a television production booth. In this example, a director or producer may directly control each of a plurality of cameras by selecting an individual camera and then directing the selected camera to perform a known camera sequence. A director may, thus, control each camera by selecting a camera and a camera movement sequence and then directing the images captured by the selected camera to a recording device or a transmitting device (not shown). In this case, the director is in direct control of the camera and the subsequent captured camera images, rather than issuing verbal instructions for camera movements that are executed by skilled camera operation personnel.

Although the invention has been described and pictured in a preferred form with a certain degree of particularity, it is understood that the present disclosure of the preferred form, has been made only by way of example, and that numerous changes in the details of construction and combination and arrangement of parts may be made without departing from the spirit and scope of the invention as hereinafter claimed.

It is expressly intended that all combinations of those elements and/or method steps which perform substantially the same function in substantially the same way to achieve the same results are within the scope of the invention. It is intended that the patent shall cover by suitable expression in the appended claims, those features of patentable novelty that exist in the invention disclosed.

I claim:

1. A method for automatically controlling the movements of at least one camera or camera lens to change the prospective of a scene viewed by said at least one camera or camera lens, said method comprising the steps of:
selecting at least one known sequence of camera parametrics from a plurality of known sequences of camera parametrics, wherein said parametrics provide instruction to control movement of said at least one camera or camera lens;
determining criteria for executing said selected known sequence of camera parametrics, wherein said criteria are responsive to high level parameters contained in said scene; and
adjusting movement of said at least one camera or camera lens in response to said determined criteria.

2. The method as recited in claim 1 wherein said at least one known sequence of camera parametrics is selected from the group of camera movements including scanning, zooming, tilting, orientating, panning, fading, zoom-and-pull-back, fade-in, fade-out.

3. The method as recited in claim 1 wherein said high level parameters include the number of objects within said scene.

4. The method as recited in claim 1 wherein said high level parameters include the position of objects within said scene.

5. The method as recited in claim 1 wherein said high level parameters include speech recognition of objects within said scene.

6. The method as recited in claim 1 wherein said high level parameters include audio inputs of objects within said scene.

7. An apparatus for automatically controlling the movements of at least one camera or camera lens to change the prospective of a scene viewed by said at least one camera or camera lens, said apparatus comprising:
a processor operative to:
receive a first input for selecting at least one known sequence of camera parametrics from a plurality of known sequences of camera parametrics, wherein said parametrics provide instruction to control movement of said at least one camera or camera lens;
receive a second input consisting of high level parameters contained in said scene;
determine criteria for executing said selected known sequence of camera parametrics, wherein said criteria are responsive to said high level parameters; and
means for adjusting movement of said at least one camera or camera lens in response to said determined criteria.

8. The apparatus as recited in claim 1 wherein said first input is selected from the group of camera movements including scanning, zooming, tilting, orientating, panning, fading, zooming, zoom-and-pull-back, fade-in, fade-out.

9. The apparatus as recited in claim 7 wherein said high level parameters include the number of objects within said scene.

10. The apparatus as recited in claim 7 wherein said high level parameters include the position of objects within said scene.

11. The apparatus as recited in claim 7 wherein said high level parameters include speech recognition of objects within said scene.

12. The apparatus as recited in claim 7 wherein said high level parameters include audio inputs of objects within said scene.

13. The apparatus as recited in claim 7 wherein said means for adjusting said camera movement includes outputting said criteria over a serial connection.

14. The apparatus as recited in claim 7 wherein said means for adjusting said camera movement includes outputting said criteria over a parallel connection.

15. The apparatus as recited in claim 7 wherein said means for adjusting said camera movement includes outputting said criteria over a network.

16. The apparatus as recited in claim 7 wherein said camera movement is accomplished electronically.

17. The apparatus as recited in claim 7 wherein said camera movement is accomplished mechanically.
